(19) United States
(12) Patent Application Publication
(10) Pub. No.: US 2018/0058258 A1
(43) Pub. Date: Mar. 1, 2018

(54) TURBOMACHINE VANE PROVIDED WITH A STRUCTURE REDUCING THE RISK OF CRACKS

(71) Applicant: Safran Aircraft Engines, Paris (FR)

(72) Inventors: Didier Noël Durand, Pontault-Combault (FR); Nicolas Daniel Delaporte, Chaumes en Brie (FR); Olivier Jean Daniel Baumas, Vert Saint Denis (FR)

(21) Appl. No.: 15/687,944

(22) Filed: Aug. 28, 2017

(30) Foreign Application Priority Data
Aug. 29, 2016 (FR) 16 58003

(51) Int. Cl. F01D 25/00; F01D 9/04; F01D 25/12

(52) U.S. Cl. CPC F01D 25/005; F01D 9/041; F01D 25/12; F05D 2250/75; F05D 2300/50212; F05D 2300/17; F05D 2220/323

(57) ABSTRACT

A vane (54) for a turbomachine, comprises an aerodynamic profile (61) formed from a body (70) made from a first material, and an add-on part (74) fixed to the body (70) by brazing and made from a second material. The add-on part (74) is housed in a recess (72) formed in a median part of an end part (73) of the body (70), between extreme parts (73A, 73B) of the end part, such that the add-on part (74) forms a median portion of the leading edge (62) of the aerodynamic profile (61). The second material has a coefficient of linear thermal expansion along the direction of the leading edge greater than that of the first material, at a normal operating temperature of the vane (54), which reduces risks of cracks appearing in the aerodynamic profile (61).

### TECHNICAL DOMAIN

This invention relates to the domain of turbomachine vanes, in particular vanes of guide vane assemblies in low pressure turbines in some turbomachines.

### STATE OF PRIOR ART

Low pressure turbines in turbomachines typically comprise a series of stages each composed of an annular row of fixed vanes supported by a turbine case, called a “guide vane assembly”, and a rotating bladed wheel typically downstream from the guide vane assembly.

High mechanical loads are applied to vanes of the guide vane assembly, possibly causing the development of cracks.

This is the case particularly for some vanes of the guide vane assembly in the stage furthest upstream in the low pressure turbine of some turbomachines.

These blades incorporate one or several channels inside which cooling air circulates after being drawn off from a compressor of the turbomachine and that in particular will supply a cavity starting from which air can penetrate into internal cooling circuits of the mobile bladed wheels of the turbine.

Therefore the aerodynamic profile of these guide vanes is subjected to high temperature gradients induced by the circulation of cooling air inside this aerodynamic profile, and by the hot core engine flow stream passing from the combustion chamber around the aerodynamic profile.

### PRESENTATION OF THE INVENTION

The purpose of the invention is particularly to reduce the risks of cracks appearing in some vanes of turbomachines, particularly concerning vanes inside which cooling air circulates and particularly vanes in the guide vane assembly furthest upstream in the low pressure turbine of some turbomachines.

To that end, the invention discloses a vane for a turbomachine, including an aerodynamic profile comprising a leading edge, a trailing edge, a pressure side wall and a suction side wall, in which the aerodynamic profile is composed of a body made of a first material with a first coefficient of linear thermal expansion along the direction of the leading edge, and an add-on part fixed to the body by brazing and made from a second material with a second coefficient of linear thermal expansion along the direction of the leading edge. The add-on part is housed in a recess formed in a median part of an end part of the body forming the leading edge, between the extreme parts of said end part of the body, such that the add-on part forms a median portion of the leading edge of the aerodynamic profile between said extreme parts. Furthermore, the second coefficient of linear thermal expansion is larger than the first coefficient of linear thermal expansion at a normal operating temperature of the vane.

After performing extensive research, the applicant determined that the risk of cracks occurring is maximum in a median region of the leading edge of the vanes. For vanes in guide vane assemblies, this would appear to be due to thermal deformations of the internal and external platforms of the guide vane assemblies, and to axial temperature gradients within the vanes. It also appears that the leading edges of vanes are affected by tension stresses that are conducive to the development of cracks in the median region of the leading edge.

Fabrication of the aerodynamic profile of the blade in two parts, namely the body and the add-on part, and the choice of a material with a higher coefficient of thermal expansion for the add-on part, can reduce mechanical stresses in the median region of the leading edge of the vanes.

In one preferred embodiment of the invention, the first and second materials are metal alloys.

Furthermore, the add-on part advantageously forms upstream parts of the pressure side and suction side walls respectively.

In the preferred embodiment of the invention, the add-on part is a plate curved so as to have two sides, forming said upstream parts of the pressure side and suction side walls respectively, and arranged on each side of a curved zone forming said median portion of the leading edge.

Each of said sides preferably has a V-shaped edge with a rounded vertex.

Furthermore, the add-on part advantageously contributes to delimiting an internal cavity inside the aerodynamic profile of the vane.

The invention is particularly advantageous when it is applied to a hollow vane, through which a cooling air flow will pass.

In this case, the add-on part may comprise at least one flow disturber on its internal surface delimiting the internal cavity.

The invention also relates to a guide vane assembly for a turbomachine comprising at least one vane of the type described above.

The invention is particularly advantageous when it is applied to a vane of a guide vane assembly.

In some cases, it may be advantageous if only some of the vanes in a guide vane assembly have the improvements disclosed in this invention, while other vanes in the same guide vane assembly are conventional vanes.

Thus, the guide vane assembly may also comprise at least one vane provided with an aerodynamic profile without an add-on part.

The invention also relates to a low pressure turbine for a twin spool turbomachine, comprising at least one guide vane assembly of the type described above.

More generally, the invention also relates to a turbomachine for an aircraft comprising at least one vane of the type described above.

### BRIEF DESCRIPTION OF THE DRAWINGS

The invention will be better understood and other details, advantages and characteristics of it will become clear after reading the following description given as a non-limitative example with reference to the appended drawings in which:

FIG. 1 is a diagrammatic axial sectional view of a turbine machine according to a preferred embodiment of the invention;

FIG. 2 is an axial sectional half-view of a low pressure turbine of the turbomachine in FIG. 1, at a larger scale;

FIG. 3 is an axial sectional half-view of the guide vane assembly of the first stage of the low pressure turbine in FIG. 2, at a larger scale;

FIG. 4 is a partial diagrammatic perspective view of a sector of the guide vane assembly in FIG. 3;

FIG. 5 is a partial diagrammatic perspective view of a body forming the aerodynamic profile of a blade of the sector of the guide vane assembly in FIG. 4;

FIGS. 6 and 7 are diagrammatic side views of an add-on part that will fit into a recess of the body visible on FIG. 5.

In all these figures, identical references may denote identical or similar elements.

### DETAILED PRESENTATION OF PREFERRED EMBODIMENTS

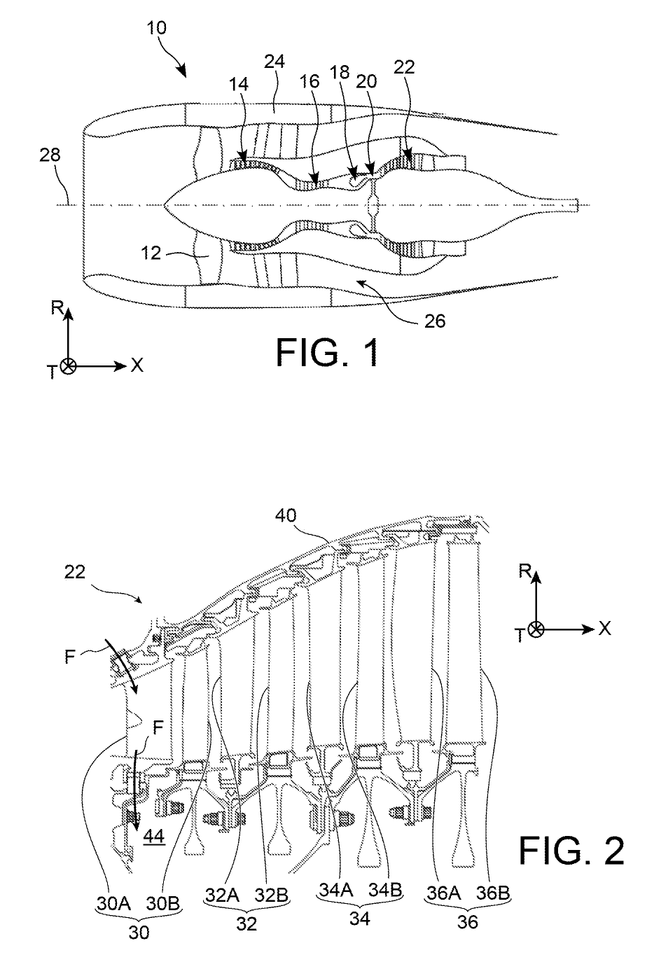

FIG. 1 illustrates a turbomachine 10 for an aircraft, for example a twin-flow twin spool turbojet comprising in general a fan 12 that will draw in an airflow dividing downstream from the fan into a core engine flow supplying the core of the turbomachine and a fan flow bypassing this core. The turbomachine generally comprises a low pressure compressor 14, a high pressure compressor 16, a combustion chamber 18, a high pressure turbine 20 and a low pressure turbine 22. The turbomachine is enclosed by a nacelle 24 surrounding the flow channel of the fan flow 26. The turbomachine rotors are installed free to rotate about a longitudinal axis 28 of the turbine machine.

Throughout this description, the axial direction X is the direction of the longitudinal axis 28 of the turbomachine, the radial direction R is a direction orthogonal to an passing through the axial direction X at all points, and the tangential direction T is orthogonal to the above two directions at all points. Furthermore, the “upstream” and “downstream” directions are defined with reference to the general flow of gases in the turbomachine.

FIG. 2 illustrates the low pressure turbine 22 of the turbomachine. In a well-known manner, this low pressure turbine is composed of a series of stages 30, 32, 34, 36 each comprising an upstream guide vane assembly 30A, 32A, 34A, 36A and a downstream bladed wheel 30B, 32B, 34B, 36B.

Each guide vane assembly 30A, 32A, 34A, 36A comprises an annular row of vanes fixed to an outer case 40 of the turbine. In the example illustrated, each guide vane assembly is composed of an assembly of sectors arranged end-to-end around the circumference.

Furthermore, the bladed wheels 30B, 32B, 34B, 36B are connected to each other so as to form a rotor of the turbine.

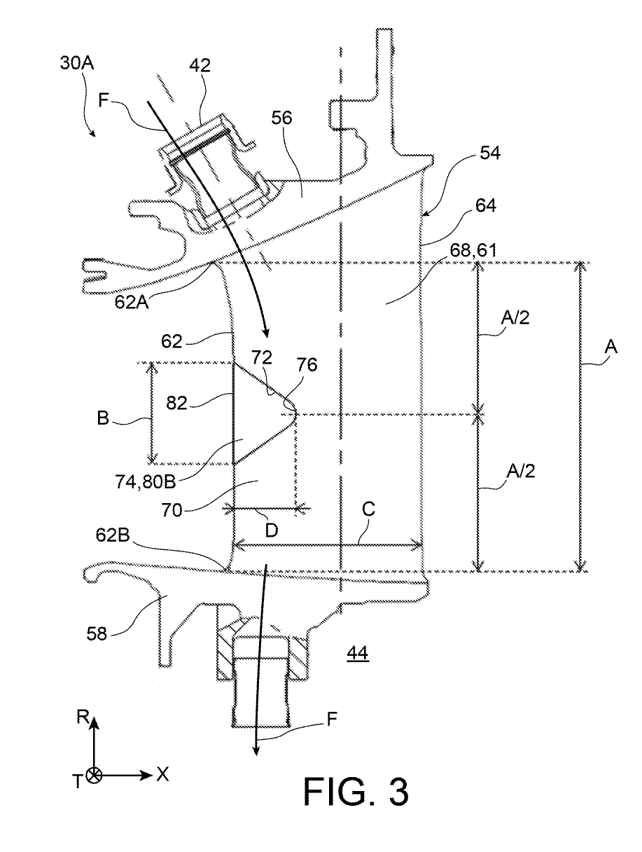

FIG. 3 more particularly shows the guide vane assembly 30A of the first stage 30, in other words the stage furthest upstream, within the low pressure turbine 22. Each of the blades of this guide vane assembly 30A includes a cooling air circuit allowing the flow of a cooling air stream F from a radially outer intake 42 to a cavity 44 formed radially inwards inside the rotor of the turbine. Part of the cooling air also cools the vanes themselves by the impact of an air jet or by the creation of an air film on the external surface of the vanes.

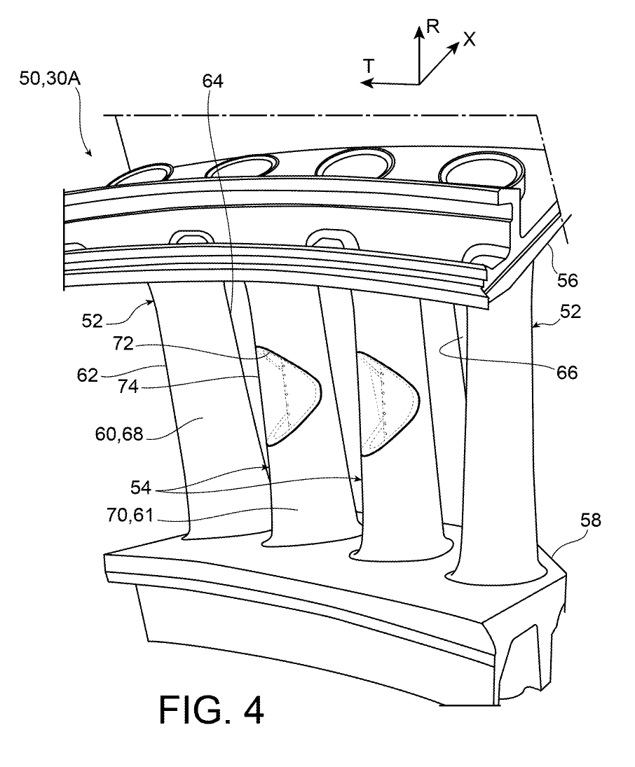

FIG. 4 also shows a sector 50 of the guide vane assembly 30A comprising four vanes, namely two vanes 52 of a conventional type, and two vanes 54 of a new type. The radially inner and radially outer ends of the vanes 52 and 54 are connected to an outer annular platform 56 and an inner annular platform 58 respectively.

In a manner known in itself, each of the vanes 52 and 54 comprises an aerodynamic profile 60, 61 comprising a leading edge 62 formed on the upstream side, a trailing edge 64 formed on the downstream side, a pressure side wall 66 and a suction side wall 68 that join together at the leading edge 62 and at the trailing edge 64.

The aerodynamic profile 60, 61 of each vane 52, 54 comprises an internal cavity. The vanes 52 and 54 also comprise an inner lining housed in the inner cavity and that will channel the cooling air flow within the vane and distribute part of this flow inside the internal cavity so as to cool the vane.

The aerodynamic profile 60 of the conventional vanes 52 is formed from a single-piece body, for example a casting.

After performing extensive research, the applicant determined that the risk of cracks occurring is maximum in a median region of the leading edge of the vanes. For guide vane assemblies, this would appear to be due to thermal deformations of the internal and external platforms, and to axial temperature gradients within the vanes. It thus appears that the leading edges of vanes are affected by tension stresses, oriented approximately along the direction of the leading edge, that are conducive to the development of cracks in the median region of the leading edge.

The applicant has also determined that in some turbomachines, two particular blades are subjected to higher stresses than the other blades in the guide vane assembly 30A, such that in the preferred embodiment of the invention, only these two vanes (marked as reference 54 on the figures) are provided with the innovative characteristics disclosed in this invention and that will now be described, so as to limit costs related to implementation of this invention.

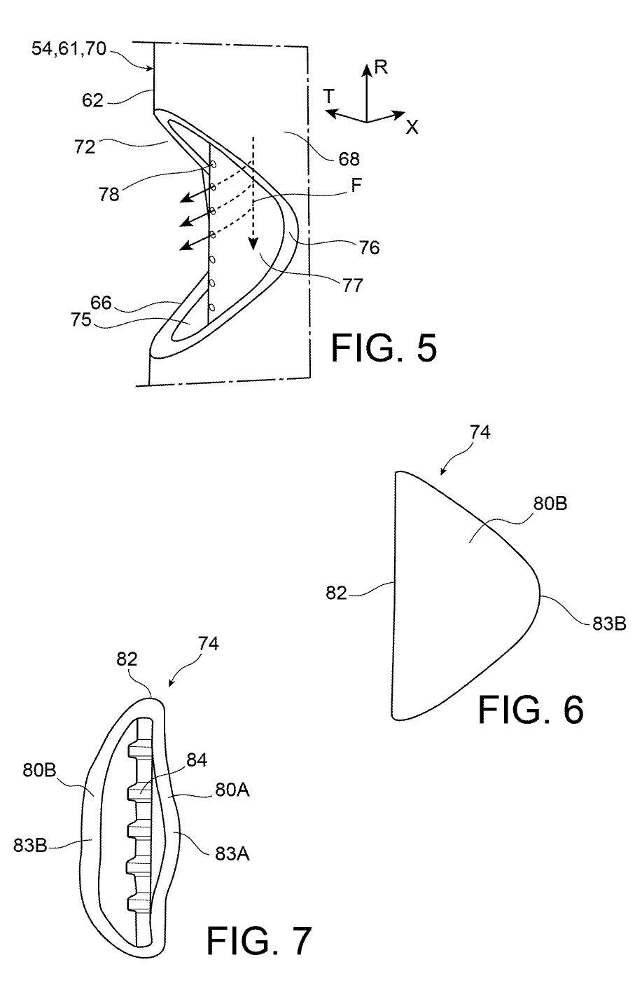

As shown on FIGS. 3-7, the vanes 54 are similar to the vanes 52 except in that the aerodynamic profile 61 of each of the vanes 54 is formed from a body 70 presenting a recess 72 formed in a median part of an end part 73 of the body 70 forming the leading edge 62, between the extreme parts 73A and 73B, in other words the radially inner and radially outer parts, of said extreme part 73 of the body 70, and an add-on part 74 that is fixed to the body 70 by brazing and is housed in the recess 72 such that the add-on part 74 forms a median portion of the leading edge 62 of the aerodynamic profile 61. The add-on part 74 is thus formed between said extreme parts 73A and 73B belonging to the body 70. Therefore the add-on part 74 contributes to delimiting the internal cavity 75 of the aerodynamic profile of the blade (visible on FIG. 5).

As can be seen more clearly on FIGS. 3 and 5, the recess 72 is in the form of a cutout formed in the body 70 from the leading edge 62, jointly in the pressure side wall 66 and the suction side wall 68. The global shape of the cutout is a V with a rounded vertex 76, open in the leading edge 62, looking at the body 70 from the side.

The rounded shape of the vertex 76 of the cutout forming the recess 72 limits stress concentrations at this vertex 76.

In the example illustrated, the depth D of the cutout forming the recess 72 in each of the walls 66 and 68 along the axial direction X, is equal to 30% of the chord C of the aerodynamic profile 61 (FIG. 3). In general, the depth D of the cutout is preferably less than or equal to 30% of the chord C, such that the strength of the body 72 remains satisfactory. Furthermore, the radial extent B of the cutout is equal to about 30% of the radial extent A of the leading edge 62. Finally, the cutout is preferably centred at equal distances from the ends 62A, 62B of the leading edge 62.

FIG. 5 also gives a glimpse of the inner lining 77 housed in the inner cavity 75 of the aerodynamic profile 61 to channel the cooling air flow F inside the vane 54 and to distribute part of this flow through the orifices 78 towards the inner surface of the aerodynamic profile 61.

FIGS. 6 and 7 show the add-on part 74 before its attachment to the body 72. This add-on part is composed of a plate, globally in the form of a diamond with rounded tips, curved at a diagonal of the diamond so as to have two sides or sides 80A, 80B extending on each side of the curved area 82. Each of said sides 80A, 80B preferably has a V-shaped edge with a rounded vertex 83A, 83B.

When the add-on part 74 is housed in the recess 72 (FIGS. 3 and 4), the curved zone 82 thus forms a median part of the leading edge 62, while the sides 80A, 80B form the upstream median portions of the pressure side wall 66 and the suction side wall 68 respectively.

In the illustrated example, the aerodynamic profile 61 is fitted with flow disturbers within its internal cavity. The add-on part 74 comprises some of these flow disturbers 84 (FIG. 7), that project from the curved zone 82 on the inner face of the add-on part.

In general, the body 70 is made of a first material with a first coefficient of linear thermal expansion along the direction of the leading edge 62 (corresponding to the radial direction R in the illustrated example), while the add-on part 74 is made from a second material with a second coefficient of linear thermal expansion along the direction of the leading edge 62. These two materials are chosen such that the second coefficient of linear thermal expansion is higher than the first coefficient of linear thermal expansion at the normal operating temperature of the vane, for example equal to 1000 degrees Celsius.

The difference between the coefficients of thermal expansion of the first and second materials reduces the mechanical stresses in the median region of the leading edge 62 of the aerodynamic profile 61, corresponding to the region in which the probability of a crack occurring is highest in known types of vanes in guide vane assemblies.

The first and second materials are preferably metal alloys.

In the preferred embodiment of the invention, the first material is thus a superalloy of nickel called “Rene 125”, for which the coefficient of linear thermal expansion at 1000 degrees Celsius is equal to 1.47E-5, while the second material is a superalloy of nickel called “Hastelloy X” (registered trademark), for which the coefficient of linear thermal expansion at 1000 degrees Celsius is equal to 1.62E-5.

As a variant, a guide vane assembly according to the invention may comprise more than two vanes 54 provided with an add-on part, or a single vane of this type.

The principle of the invention can also be applied to other vanes within turbomachines, particularly to vanes in guide vane assemblies of other stages of low pressure turbines or vanes of the guide vane assembly of a high pressure turbine, or blades of bladed wheels.

1. Vane (54) for a turbomachine, including an aerodynamic profile (61) comprising a leading edge (62), a trailing edge (64), a pressure side wall (66) and a suction side wall (68),
wherein the aerodynamic profile (61) is formed from a body (70) made of a first material with a first coefficient of linear thermal expansion along the direction of the leading edge, and an add-on part (74) fixed to the body (70) by brazing and made from a second material with a second coefficient of linear thermal expansion along the direction of the leading edge,
the add-on part (74) being housed in a recess (72) formed in a median part of an end part (73) of the body (70), said end part (73) forming the leading edge (62), said median part being defined between extreme parts (73A, 73B) of said end part (73) of the body (70), such that the add-on part (74) forms a median portion of the leading edge (62) between said extreme parts (73A, 73B).
and the second coefficient of linear thermal expansion is larger than the first coefficient of linear thermal expansion at a normal operating temperature of the vane (54).

2. Vane according to claim 1, wherein the first and second materials are metal alloys.

3. Vane according to either claim 1, wherein the add-on part (74) forms upstream parts of the pressure side wall (66) and suction side wall (68) respectively.

4. Vane according to claim 3, wherein the add-on part (74) is a plate curved so as to have two sides (80A, 80B), forming said upstream parts of the pressure side wall (66) and suction side wall (68) respectively, and arranged on each side of a curved zone (82) of the add-on part (74), forming said median portion of the leading edge (62).

5. Vane according to claim 4, wherein each of said sides (80A, 80B) has a V-shaped edge with a rounded vertex (83A, 83B).

6. Vane according to claim 1, wherein the add-on part (74) contributes to delimiting an internal cavity (75) inside the aerodynamic profile (61) of the vane (54).

7. Vane according to claim 6, wherein the add-on part (74) comprises at least one flow disturber (84) on its internal surface delimiting the internal cavity (75).

8. Guide vane assembly (30A) for a turbomachine, comprising at least one vane (54) according to claim 1.

9. Guide vane assembly according to claim 8, also comprising at least one vane (52) provided with an aerodynamic profile (60) without an add-on part.

10. Low pressure turbine (22) for a twin spool turbomachine, comprising at least one guide vane assembly (30A) according to claim 8.

11. Turbomachine (10) for an aircraft, comprising at least one vane (54) according to claim 1.
